(19) United States
(12) Patent Application Publication
(10) Pub. No.: US 2008/0164132 A1
(43) Pub. Date: Jul. 10, 2008

(54) Button input device using E-paper

(75) Inventors: Ho-joon Yoo, Seoul (KR); Sun-gi Hong, Yongin-si (KR); Nam-woo Kim, Hanam-si (KR); Seong-woon Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/984,104

(22) Filed: Nov. 13, 2007

(30) Foreign Application Priority Data
Jan. 4, 2007 (KR) 10-2007-0001158

(51) Int. Cl. H01H 13/70; H01H 3/12

(52) U.S. Cl. 200/5 A; 200/341

(57) ABSTRACT

Provided is a button input device using electronic paper (E-paper). The button input device includes: a button including a transparent window and at least one base portion downwardly protruding from an outer edge of the window; the E-paper including a display region disposed under the window, and at least one hole disposed outside the display region and allowing the base portion of the button to be inserted thereinto; an elastic member disposed under the E-paper and elastically deformed by the base portion of the button when the button is pressed; and a switch circuit board including a switch disposed under the elastic member at a position corresponding to a lower end of the base portion of the button and generating a signal when the button is pressed.

### CROSS-REFERENCE TO RELATED APPLICATIONS

This application claims the priority benefit of Korean Patent Application No. 10-2007-0001158, filed on Jan. 4, 2007, in the Korean Intellectual Property Office, the disclosure of which is incorporated herein in its entirety by reference.

### BACKGROUND

1. Field

Embodiments relate to a button input device using electronic paper (E-paper), and more particularly, to a button input device that can display various characters or symbols through windows of buttons using E-paper and provide an operation feeling (tactile sensation) to a user without applying physical pressure to the E-paper during the operation of the buttons.

2. Description of the Related Art

In general, button input devices generate a switch signal in response to a user's press. As systems employing a button input device and having various functions have recently been suggested, many alphanumeric characters or symbols have been used on each button. For example, one digit, two or three English characters, and one or two Korean characters have been used on each button. When there are many alphanumeric characters or symbols on each button, visibility thereof may be degraded. To address this problem, a key input device using electronic paper (E-paper) in which many characters or symbols are used on each button has been suggested in Japanese Patent Laid-open No. 2005-352987.

Users are familiar with push buttons. Accordingly, when a user presses a button, button input devices should provide a predetermined operation feeling (tactile sensation) to the user so that the user can know that the button has been correctly pressed. In order to provide an operation feeling (tactile sensation) when a button is pressed and released, most conventional button input devices include a dome switch and an elastic member such as a rubber pad or a leaf spring.

There are many limitations to the manufacture of button input devices that can display various characters or symbols and provide a button operation feeling (tactile sensation) using E-paper. In particular, most types of E-paper are configured such that charged ink capsules are disposed between thin electrodes although there is a slight difference in the arrangement of the ink capsules. Accordingly, if excessive pressure is applied to the E-paper or pressure is applied to the E-paper for a long period of time, the positions of the ink capsules in the E-paper may be changed or the electrodes may be damaged. Also, if the E-paper is repeatedly deformed, the lifespan of the E-paper may be further shortened although the E-paper is flexible. Accordingly, button input devices that can prevent E-paper from being deformed by pressure are required.

### SUMMARY

Exemplary embodiments provide a button input device that can display various alphanumeric characters or symbols through windows of buttons using electronic (E-paper) and provide an operation feeling (tactile sensation) to a user without applying physical pressure to the E-paper during the operation of the buttons.

Exemplary embodiments also provide a button input device that can display alphanumeric characters or symbols using one E-paper with respect to a plurality of buttons in order to easily manufacture a button input device module with an array of buttons.

According to an aspect of exemplary embodiments, there is provided a button input device including a button including a transparent window and at least one base portion downwardly protruding from an outer edge of the transparent window; an electronic paper (E-paper) including a display region disposed under the transparent window, and a hole disposed outside the display region and allowing the base portion of the button to pass through the E-paper; an elastic member which is disposed under the E-paper and which is elastically deformed by the base portion of the button when the button is pressed; and a switch circuit including a switch, which is disposed under the elastic member at a position corresponding to a lower end of the base portion of the button and which generates a signal when the button is pressed.

An exemplary embodiment of button input device may further include a button guide plate, which is disposed over the E-paper, which has a hole formed at a position corresponding to the button, and which guides a vertical stroke of the button.

The elastic member may be an elastic plate. The elastic plate may be formed of a soft and flexible polymer material such as rubber. The elastic plate may have a bottom surface on which a projection is formed at a position corresponding to the base portion of the button and the switch to project toward the switch.

The E-paper may be hard enough to support side surfaces of the base portion of the button and to guide a vertical stroke of the button. In case the E-paper is not sufficiently hard, the button input device may further comprise a button base guide plate disposed between the E-paper and the elastic member, the button base guide plate having a hole through which the base portion of the button passes, and the button base guide plate formed of a material hard enough to support side surfaces of the base portion of the button and to guide a vertical stroke of the button.

The display region of the E-paper may be patterned to selectively display various characters or symbols through the transparent window of the button.

According to another aspect of an exemplary embodiment, there is provided a button input device including a plurality of buttons arranged at the same level, each of the buttons including a transparent window and a base portion downwardly protruding from an outer edge of the transparent window; an electronic paper (E-paper) including a plurality of display regions respectively disposed under the transparent windows of the buttons and a plurality of holes through which the base portions of the plurality of buttons respectively pass through; an elastic member which is disposed under the E-paper and which is elastically deformed by the base portions of the buttons when the buttons are pressed; and a switch circuit including a plurality of switches, which are disposed under the elastic member at positions respectively corresponding to lower ends of the base portions of the plurality of buttons, and which generate a signal when the buttons are pressed. The button input device may further include a button guide plate disposed over the E-paper, having a plurality of holes formed at positions respectively corresponding to the plurality of buttons, and guiding vertical strokes of the respective buttons.

The elastic member may be an elastic plate integrally formed with portions corresponding to the plurality of buttons. The elastic plate may be formed of a soft and flexible polymer material such as rubber. The elastic plate may have a bottom surface on which a plurality of projections are formed at positions corresponding to the base portions of the plurality of buttons and the plurality of switches to project toward the switches.

The E-paper may be hard enough to support side surfaces of the base portions of the buttons and guide the vertical strokes of the buttons. In case the E-paper is not sufficient hard, the button input device may further include a button base guide plate disposed between the E-paper and the elastic member, having a plurality of holes into which the base portions of the plurality of buttons respectively pass through, and formed of a material hard enough to support side surfaces of the base portions of the buttons and guide vertical strokes of the buttons.

The display regions of the E-paper may be patterned to selectively display various characters or symbols through the transparent windows of the plurality of buttons.

According to another aspect of the present invention an exemplary embodiment, there is provided a button input device including a button including a transparent window and a plurality of base portions downwardly protruding from outer edges of the transparent window; an electronic paper (E-paper) including a display region disposed under the transparent window, and a plurality of holes disposed outside the display region and allowing the base portions of the button to pass through the E-paper; an elastic member which is disposed under the E-paper and which is elastically deformed by the base portions of the button when the button is pressed; and a switch circuit including a switch, which is disposed under the elastic member at a position corresponding to a lower end of the base portions of the button and which generates a signal when the button is pressed.

According to another aspect of the present invention an exemplary embodiment, there is provided a method for generating a signal using a button input device including pressing a button including a transparent window and a base portion downwardly protruding from an outer edge of the transparent window in a vertical direction so that the bottom of the base portion passes through a hole outside of a display region of an electronic paper (E-paper) disposed under the transparent window and deforms an elastic member which is disposed under the E-paper and has a projection corresponding to the base member in order to bring a switch of a switch circuit disposed below the elastic member into contact with the projection; and generating the signal when the button is pressed to bring the switch into contact with the projection.

### BRIEF DESCRIPTION OF THE DRAWINGS

These and/or other aspects, features, and advantages will become apparent and more readily appreciated from the following description of exemplary embodiments, taken in conjunction with the accompanying drawings of which:

FIG. 1 is a cross-sectional view of a button input device according to an exemplary embodiment;

FIG. 2 is a cross-sectional view of a button input device according to another exemplary embodiment;

FIG. 3 is a perspective view illustrating a button guide plate of the button input device of FIG. 1;

FIG. 4 is a perspective view illustrating a plurality of buttons of the button input device of FIG. 1;

FIGS. 5A and 5B are perspective views illustrating electronic paper (E-paper) of the button input device of FIG. 1;

FIG. 6 is a perspective view illustrating a button base guide plate of the button input device of FIG. 1;

FIG. 7 is a perspective view illustrating an elastic plate of the button input device of FIG. 1; and

FIG. 8 is a perspective view illustrating a switch circuit board of the button input device of FIG. 1.

### DETAILED DESCRIPTION OF EMBODIMENTS

Reference will now be made in detail to exemplary embodiments, examples of which are illustrated in the accompanying drawings, wherein like reference numerals refer to the like elements throughout. Exemplary embodiments are described below to explain the present invention by referring to the figures.

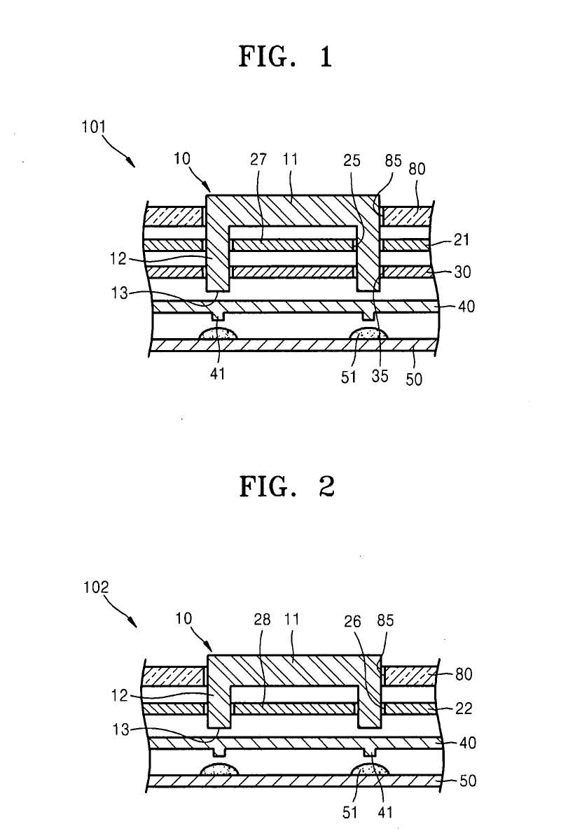

FIG. 1 is a cross-sectional view of a button input device 101 according to an exemplary embodiment. Referring to FIG. 1, the button input device 101 includes buttons 10 each having a base portion 12 and a transparent window 11, a switch circuit board 50 disposed under the base portions 12 of the buttons 10, and electronic paper (E-paper) 21, a button base guide plate 30, and an elastic plate 40, which is an elastic member, sequentially disposed between the windows 11 of the buttons 10 and the switch circuit board 50. The base portions 12 of the buttons 10 downwardly protrude from outer edges of the windows 11. Holes 25 and 35 into which the base portions 12 of the buttons 10 are inserted are respectively formed in the E-paper 21 and the button base guide plate 30. The base portions 12 of the buttons 10 are inserted into the holes 25 and 35 to pass through the E-paper 21 and the button base guide plate 30 such that lower ends 13 of the base portions 12 contact the elastic plate 40. Switches 51 are disposed on a top surface of the switch circuit board 50 at positions respectively corresponding to the base portions 12 of the buttons 10 and generate a signal when the buttons 10 are pressed.

A button guide plate 80 may be disposed over the E-paper 21, have holes 85 formed at positions respectively corresponding to the windows 11 of the buttons 10, and guide the vertical strokes of the buttons 10. The button guide plate 80 may be a part of a case of an electronic device.

Both the base portions 12 and the windows 11 of the buttons 10 may be formed of a transparent material, or only the windows 10 of the buttons 10 may be formed of a transparent material. Two or more base portions 12 of equal length may protrude from each of the windows 11 considering the balance of each of the buttons 10.

The E-paper 21 has display regions 27 disposed under the windows 11 of the buttons 10. The E-paper 21 may be E-paper of a pattern type in which various characters or symbols are previously patterned using electronic ink capsules on the display regions 27. The pattern type E-paper has an advantage in that holes can be made into portions with no pattern. Electrode patterns connected to the electronic ink capsule patterns of the characters or symbols may skirt around the holes 25. However, the E-paper 21 is not limited to the pattern type E-paper. That is, the E-paper 21 may be of a matrix type if electrode patterns can skirt around the holes 25.

The E-paper 21 may be formed of a hard material, or a soft material that can be easily bent. However, when the E-paper 21 is not hard enough to support side surfaces of the base portions 12 of the buttons 10 and guide the strokes of the buttons 10, the button base guide plate 30 formed of a material harder than that of the E-paper 21 may be disposed under the E-paper 21. The stiffness of the button base guide plate 30 may be high enough to support the side surfaces of the base portions 12 of the buttons 10 without being deformed around the holes when portions other than the centers of the buttons 10 are pressed.

The elastic plate 40 is an elastic member that returns the buttons 10, which are pressed and thus the lower ends 13 of the base portions 12 are pressed onto the switches 51, to their original positions. The elastic plate 40 may be formed of a soft and flexible polymer material such as rubber. Projections 41 may be formed on a bottom surface of the elastic plate at positions respectively corresponding to the base portions 12 of the buttons 10 and the switches 51 to project toward the switches 51.

The switch circuit board 51 may be a printed circuit board (PCB) and include the switches 51 disposed at predetermined positions on the PCB. The switches 51 may be any switches that can generate a signal in response to a button press. Mobile electronic devices, such as mobile communication terminals, generally employ dome switches. However, the switches 51 according to the present exemplary embodiment is not limited to the dome switches.

FIG. 2 is a cross-sectional view of a button input device 102 according to another exemplary embodiment. Referring to FIG. 2, the button input device 102 includes buttons 10 each having a base portion 12 and a transparent window 11, a switch circuit board 50 disposed under the base portions 12 of the buttons 10, and E-paper 22 and an elastic plate 40, which is an elastic member, sequentially disposed between the windows 11 of the buttons 10 and the switch circuit board 50. The base portions 12 of the buttons 10 downwardly protrude from outer edges of the windows 11. Holes 26 into which the base portions 12 of the buttons 10 are inserted are formed in the E-paper 22. The base portions 12 of the buttons 10 are inserted into the holes 26 to pass through the E-paper 22, such that lower ends 13 of the base portions 12 contact the elastic plate 40. Switches 51 are disposed on a top surface of the switch circuit board 50 at positions respectively corresponding to the base portions 12 of the buttons 10 and generate a signal when the buttons 10 are pressed.

The E-paper 22 is formed of a material having a stiffness high enough to support side surfaces of the base portions 12 of the buttons 10 and guide the vertical strokes of the buttons 10 without being deformed around the holes 26 when portions other than the centers of the buttons 10 are pressed. The E-paper 22 has display regions 28 disposed under the windows 11 of the buttons 10.

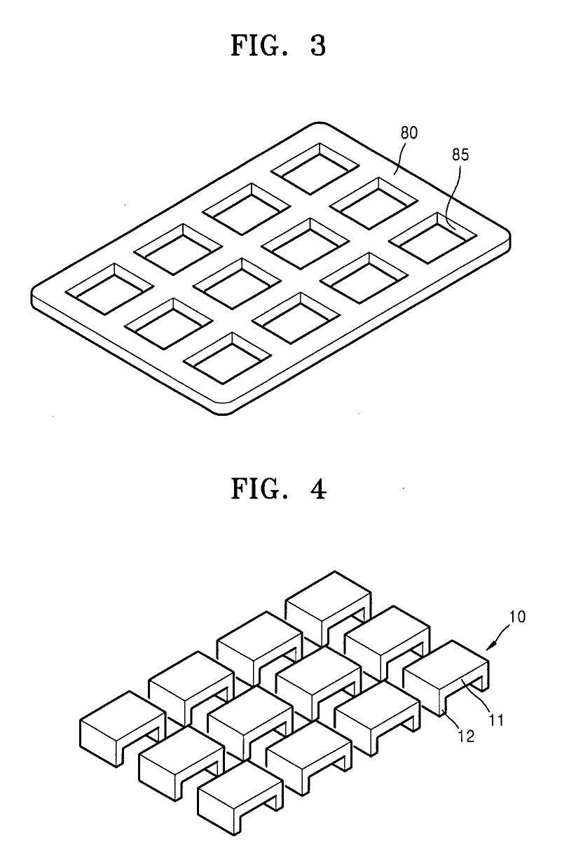

FIG. 3 is a perspective view illustrating the button guide plate 80 of the button input device 101 of FIG. 1. In general, button input devices used in portable electronic devices, such as mobile communication terminals (devices), include an array of buttons of the same height, not each button. Mobile communication terminals include but are not limited to personal digital assistants (PDAs), portable multimedia players (PMPs), and mobile phones. In this case, the button guide plate 80 has the plurality of holes 85 corresponding to the respective buttons 10. The holes 85 may be large enough to expose the entire windows 11 of the buttons 10, respectively.

FIG. 4 is a perspective view illustrating the plurality of buttons 10 of the button input device 101 of FIG. 1. The plurality of buttons are 10 are arranged in parallel to one another. The shapes and arrangement of the plurality of buttons 10 are exemplarily shown in FIG. 4. The base portions 12 of each of the buttons 10 may be symmetrical about each of the windows 11.

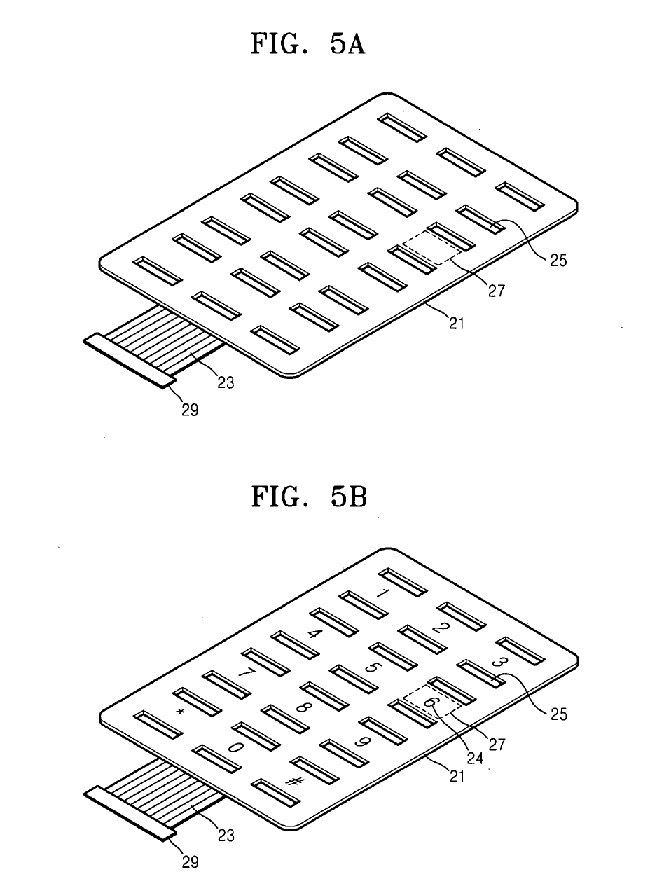

FIGS. 5A and 5B are perspective views illustrating the E-paper 21 of the button input device 101 of FIG. 1. The E-paper 21 has the plurality of holes 25 formed at positions respectively corresponding to the base portions 12 of the plurality of buttons 10 as described above. The plurality of display regions 27 are disposed at portions that are seen through the windows 11 of the buttons 10, that is, at positions respectively corresponding to the windows 11 of the respective buttons 10 to selectively display various characters or symbols. The various characters or symbols are patterned on the display regions 27 using electronic ink capsules, and any one of patterns 24 may be selectively activated by electrode patterns connected to the electronic ink capsules. To this end, the electrode patterns are connected to a driving unit (not shown) outside the E-paper 21 via a signal cable 23. The driving unit may be disposed on a circuit board of an electronic device and a connector 29 may be disposed at an end of the signal cable 23 to facilitate connection with the circuit board.

The E-paper 21 may be a single sheet corresponding to the plurality of buttons 10 as shown in FIGS. 5A and 5B, to reduce time and cost required to manufacture and assemble components of the button input device module with the plurality of buttons 10 or the electronic device.

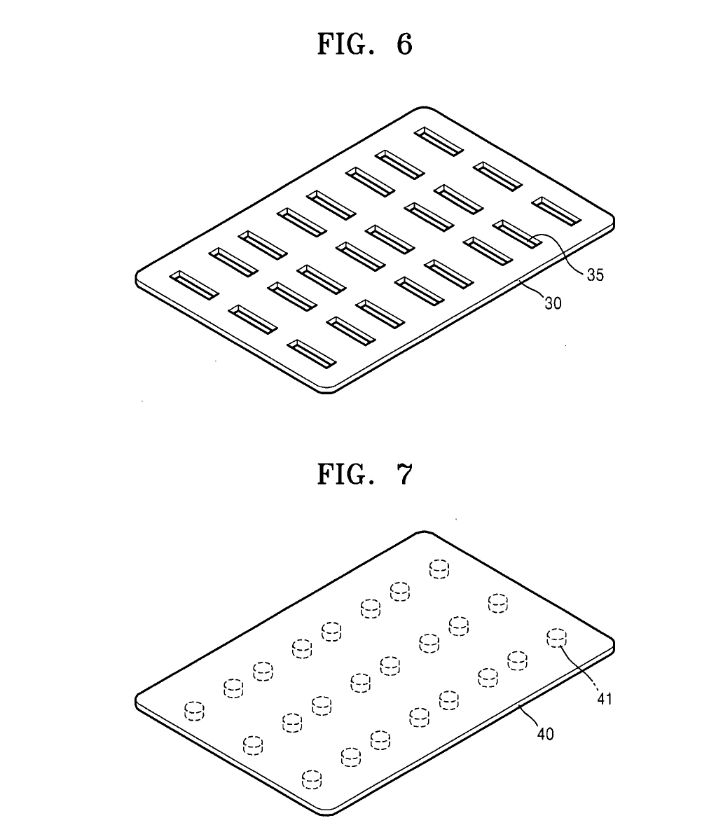

FIG. 6 is a perspective view illustrating the button base guide plate 30 of the button input device 101 of FIG. 1. The button base guide plate 30 has also the holes 35 formed at positions respectively corresponding to the base portions 12 of the plurality of buttons 10.

FIG. 7 is a perspective view illustrating the elastic plate 40 of the button input device 101 of FIG. 1. The elastic plate 40 may be formed of a soft and flexible material, such as rubber, as described above, and may be integrally formed with portions corresponding to the plurality of buttons 10 like the E-paper 21 and the button base guide plate 30. The plurality of projections 41 may be disposed on the bottom surface of the plastic plate 40 at positions respectively corresponding to the base portions 12 of the plurality of buttons 10.

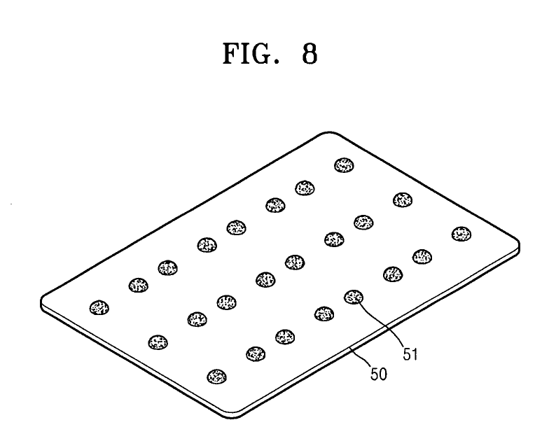

FIG. 8 is a perspective view illustrating the switch circuit board 50 of the button input device 101 of FIG. 1. The plurality of dome switches 51 are disposed on the top surface of the switch circuit board 50 at positions respectively corresponding to the base portions 12 of the plurality of buttons 10. The dome switches 51 may be disposed to correspond to the buttons 10 in a one-to-one fashion. The switch circuit board 50 and a main substrate of the electronic device in which the button input device 101 is to be installed may be integrally formed with each other. Alternatively, when the number of components mounted on the main substrate is high, the switch circuit board 60 may be separated from the main substrate.

As described above, the button input device using the E-paper according to an exemplary embodiment can display various alphanumeric characters or symbols through the windows using the E-paper, and provide an operation feeling (tactile sensation) to a user without applying physical pressure to the E-paper during an operation of the buttons, thereby enhancing the durability of the button input device.

Furthermore, since the button input device using the E-paper can provide characters or symbols using one E-paper with respect to a plurality of buttons, the button input device module or the electronic device with the array of buttons can be easily manufactured.

Moreover, since the E-paper is disposed over the switch circuit board, the button input device using the E-paper can prevent the display regions on which information is displayed from being covered by other members, thereby efficiently using the E-paper.

Although a few exemplary embodiments have been shown and described, it would be appreciated by those skilled in the art that changes may be made in these exemplary embodiments, the scope of which is defined in the claims and their equivalents.

What is claimed is:

1. A button input device comprising:
a button including a transparent window and a base portion downwardly protruding from an outer edge of the transparent window;
an electronic paper (E-paper) including a display region disposed under the transparent window, and a hole disposed outside the display region and allowing the base portion of the button to pass through the E-paper;
an elastic member which is disposed under the E-paper and which is elastically deformed by the base portion of the button when the button is pressed; and
a switch circuit including a switch, which is disposed under the elastic member at a position corresponding to a lower end of the base portion of the button and which generates a signal when the button is pressed.

2. The button input device of claim 1, further comprising a button guide plate, which is disposed over the E-paper, which has a hole formed at a position to accommodate the button, and which guides a vertical stroke of the button.

3. The button input device of claim 1, wherein the elastic member is an elastic plate.

4. The button input device of claim 3, wherein the elastic plate has a bottom surface on which a projection is formed at a position corresponding to the base portion of the button and the switch to project toward the switch.

5. The button input device of claim 1, wherein the E-paper is hard enough to support side surfaces of the base portion of the button and to guide a vertical stroke of the button.

6. The button input device of claim 1, further comprising a button base guide plate disposed between the E-paper and the elastic member, the button base guide plate having a hole through which the base portion of the button passes, and the button base guide plate formed of a material hard enough to support side surfaces of the base portion of the button and to guide a vertical stroke of the button.

7. The button input device of claim 1, wherein the display region of the E-paper is patterned to selectively display various characters or symbols through the transparent window of the button.

8. A button input device comprising:
a plurality of buttons arranged at the same level, each of the buttons including a transparent window and a base portion downwardly protruding from an outer edge of the transparent window;
an electronic paper (E-paper) including a plurality of display regions respectively disposed under the transparent windows of the buttons and a plurality of holes through which the base portions of the plurality of buttons respectively pass through;
an elastic member which is disposed under the E-paper and which is elastically deformed by the base portions of the buttons when the buttons are pressed; and
a switch circuit including a plurality of switches, which are disposed under the elastic member at positions respectively corresponding to lower ends of the base portions of the plurality of buttons, and which generate a signal when the buttons are pressed.

9. The button input device of claim 8, further comprising a button guide plate, which is disposed over the E-paper, which has a plurality of holes formed at positions to respectively accommodate the plurality of buttons, and which guides vertical strokes of the respective buttons.

10. The button input device of claim 8, wherein the elastic member is an elastic plate integrally formed with portions corresponding to the plurality of buttons.

11. The button input device of claim 10, wherein the elastic plate has a bottom surface on which a plurality of projections are formed at positions corresponding to the base portions of the plurality of buttons and the plurality of switches to project toward the switches.

12. The button input device of claim 8, wherein the E-paper is hard enough to support side surfaces of the base portions of the buttons and to guide vertical strokes of the buttons.

13. The button input device of claim 8, further comprising a button base guide plate disposed between the E-paper and the elastic member, the button base guide plate having a plurality of holes through which the base portions of the plurality of buttons respectively pass, and the button base guide plate formed of a material hard enough to support side surfaces of the base portions of the buttons and to guide vertical strokes of the buttons.

14. The button input device of claim 8, wherein the display regions of the E-paper are patterned to selectively display various characters or symbols through the transparent windows of the plurality of buttons.

15. A button input device comprising:
a button including a transparent window and a plurality of base portions downwardly protruding from outer edges of the transparent window;
an electronic paper (E-paper) including a display region disposed under the transparent window, and a plurality of holes disposed outside the display region and allowing the base portions of the button to pass through the E-paper;
an elastic member which is disposed under the E-paper and which is elastically deformed by the base portions of the button when the button is pressed; and
a switch circuit including a switch, which is disposed under the elastic member at a position corresponding to a lower end of the base portions of the button and which generates a signal when the button is pressed.

16. The button input device of claim 15, further comprising a button guide plate, which is disposed over the E-paper, which has holes formed at positions to accommodate the button, and which guides a vertical stroke of the button.

17. The button input device of claim 15, wherein the elastic member is an elastic plate.

18. The button input device of claim 17, wherein the elastic plate has a bottom surface on which projections are formed at positions corresponding to the base portions of the button and the switches to project toward the switches.

19. The button input device of claim 15, wherein the E-paper is hard enough to support side surfaces of the base portions of the button and to guide a vertical stroke of the button.

20. The button input device of claim 15, further comprising a button base guide plate disposed between the E-paper and the elastic member, the button base guide plate having a holes through which the base portions of the button passes, and the button base guide plate formed of a material hard enough to support side surfaces of the base portions of the button and to guide a vertical stroke of the button.

21. The button input device of claim 1, wherein the display region of the E-paper is patterned to selectively display various characters or symbols through the transparent window of the button.

22. A method for generating a signal using a button input device, comprising:
pressing a button including a transparent window and a base portion downwardly protruding from an outer edge of the transparent window in a vertical direction so that the bottom of the base portion passes through a hole outside of a display region of an electronic paper (E-paper) disposed under the transparent window and deforms an elastic member which is disposed under the E-paper and has a projection corresponding to the base member in order to bring a switch of a switch circuit disposed below the elastic member into contact with the projection; and
generating the signal when the button is pressed to bring the switch into contact with the projection.
